(19) United States
(12) Patent Application Publication
(10) Pub. No.: US 2015/0033235 A1
(43) Pub. Date: Jan. 29, 2015

(54) Distributed Mechanism For Minimizing Resource Consumption

(71) Applicants: David Engdal, Torslanda (SE); Peter Brauer, Lodose (SE); Martin Lundqvist, Molndal (SE)

(72) Inventors: David Engdal, Torslanda (SE); Peter Brauer, Lodose (SE); Martin Lundqvist, Molndal (SE)

(73) Assignee: Telefonaktiebolaget L M Ericsson (publ), Stockholm (SE)

(21) Appl. No.: 14/376,646

(22) PCT Filed: Feb. 9, 2012
(86) PCT No.: PCT/EP2012/052156

§ 371 Date: Aug. 5, 2014

(51) Int. Cl. G06F 9/48; G06F 9/50

(52) U.S. Cl. CPC G06F 9/4881; G06F 9/5094
USPC 718/102

(57) ABSTRACT

Example embodiments presented herein are directed towards multi-core processing providing in a distributed manner with an emphasis on power management. The example embodiments provide a processing node, and method therein, for the distribution of processing tasks, and energy saving mechanisms, which are performed autonomously.

### TECHNICAL FIELD

The example embodiments presented herein are directed towards a processing node, and method therein, for performing tasks in a distributed manner with minimized resource consumption.

### BACKGROUND

Software signal processing applications are not often exclusively static environments, for example, the dynamics of a radio base station baseband application may be multidimensional and constantly shifting. The need for processing resources can vary greatly. This need may depend on a current scheduling, which may be valid for one millisecond before it instantly changes again, while the requirements on processing latency are continuously tight and rigorous.

Due to strong trends in hardware architecture, an application as the one described above has to be able to execute well when deployed on a distributed hardware platform or more specifically a multi-core processor, while at the same time keeping the power consumption at a minimum. When executing such a concurrent software design on a multi-core processor, there is a need for real-time scheduling of processing resources. Resource schedulers employed today are often limited to being centralized, statically occupying processing resources themselves.

### SUMMARY

The systems described above scale badly when migrating to differently sized multi-core environments, and also become a possible bottleneck in an executing implementation. Furthermore, more focus is needed on the possibilities of minimizing the power consumption of these distributed software applications, in order not to consume more energy than is actually required at any given instant. In many cases processing resources are always active, consuming a certain amount of energy, regardless of whether they are performing any valuable processing or not. In some cases, resource schedulers may have some limited control of powering up or down entire chips or clusters of processors, but in an extent too slow and too coarse-grained to be of any practical value in such complex and rapidly dynamic systems as the ones intended in this disclosure.

Thus, an object of the example embodiments presented herein is to provide a distributed multi-core processing system which performs tasks in an efficient manner and conserves energy or system resources. Accordingly, some of the example embodiments presented herein may be directed towards a method, in a processing node, where the processing node is one of a plurality of processing nodes configured to perform parallel processing. The method comprises self-assigning at least one unscheduled task to be processed, and determining a presence of at least one inactive processing node. The method also comprises altering an activity status based on the presence of at least one other unscheduled task, where the self-assigning and altering are performed in a fully distributed manner.

Some of the example embodiments may be directed towards a processing node, where the processing node is one of a plurality of processing nodes configured to perform parallel processing. The processing node comprises a self-assigning unit configured to self-assign at least one unscheduled task to be processed, and a determining unit configured to determine a presence at least one inactive processing node. The processing node also comprises an altering unit configured to alter an activity status based on the presence of at least one other unscheduled task, where the self-assigning and altering are performed in a fully distributed manner. Some of the example embodiments are directed towards a system comprising a plurality of processing nodes as described above.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A is an illustrative example of a processing system featuring a centralized resource scheduler;

FIG. 1B is an illustrative example of a processing system, according to some of the example embodiments;

FIG. 2 is an example processing node, according to some of the example embodiments;

FIG. 3 is a flow diagram depicting example operational steps which may be taken by the processing node of FIG. 2, according to some of the example embodiments; and

FIGS. 4-7 are flow diagrams illustrating example processing methods, according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, the example embodiments may be practiced in other manners that depart from these specific details. In other instances, detailed descriptions of well-known methods and elements are omitted so as not to obscure the description of the example embodiments.

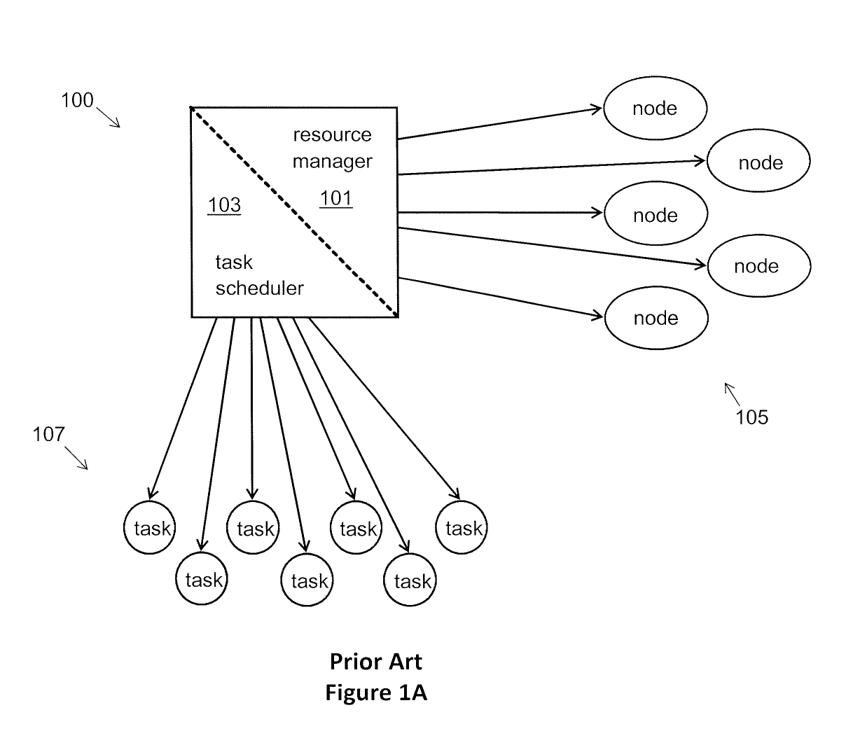

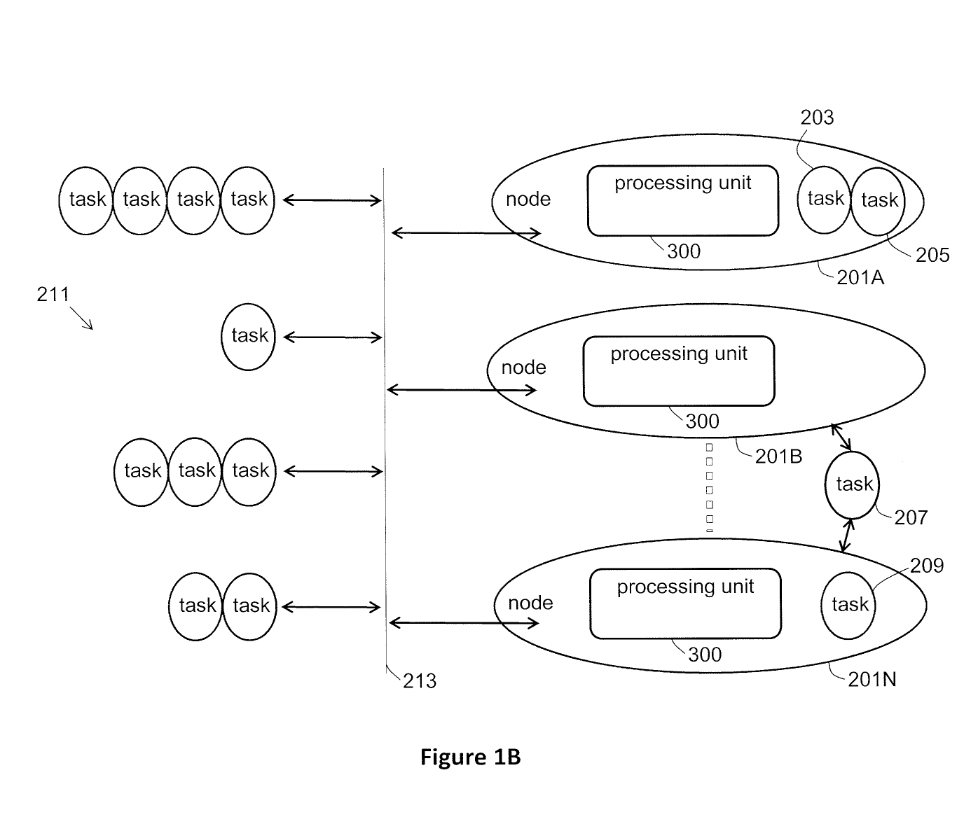

Example embodiments presented herein are directed towards providing an efficient means for system processing. For explanation purposes, a problem will first be identified and discussed. FIG. 1A illustrates a dynamic power management multi-core processing system known in the art. The processing system comprises a centralized distribution unit 100 featuring a resource manager 101 and a task scheduler 103. The resource manager 101 is configured to monitor the processing and available resources of a number of processing nodes 105. The task scheduler 103 is configured to distribute unscheduled tasks 107 to different processing nodes 105.

The processing of the system illustrated in FIG. 1A may be handled in one of three ways. First, a high energy consumption method may be employed where all systems resources are always turned on. Second, an offline optimization method may be employed where a best utilization scheme is calculated for each load case offline and executed in the real time system. Third, a centralized method may be utilized here the central distribution unit 100 is always on and calculates the method of distribution.

Various problems exist with the methods described above. The high energy consumption method does not utilize power management and is therefore wasteful of system resources. The offline optimization method may be difficult to implement in practice as it is impossible to foresee all possible load cases. The centralized method requires a large amount of communication between the centralized distribution unit 100 and all of the resources needed for statistics and control. The centralized distribution method is also difficult to scale from smaller systems to larger systems. As the number of processing cores increase, the load of the centralized distribution unit 100 will also increase. For example, the signalling for status updates will increase, eventually reaching time and/or processing limits.

Thus, a need exists for a scalable multi-core processing system which utilizes minimized system resources. Thus, some of the example embodiments presented herein may be directed towards a system which utilizes distributed autonomous scheduling and power management in an efficient manner.

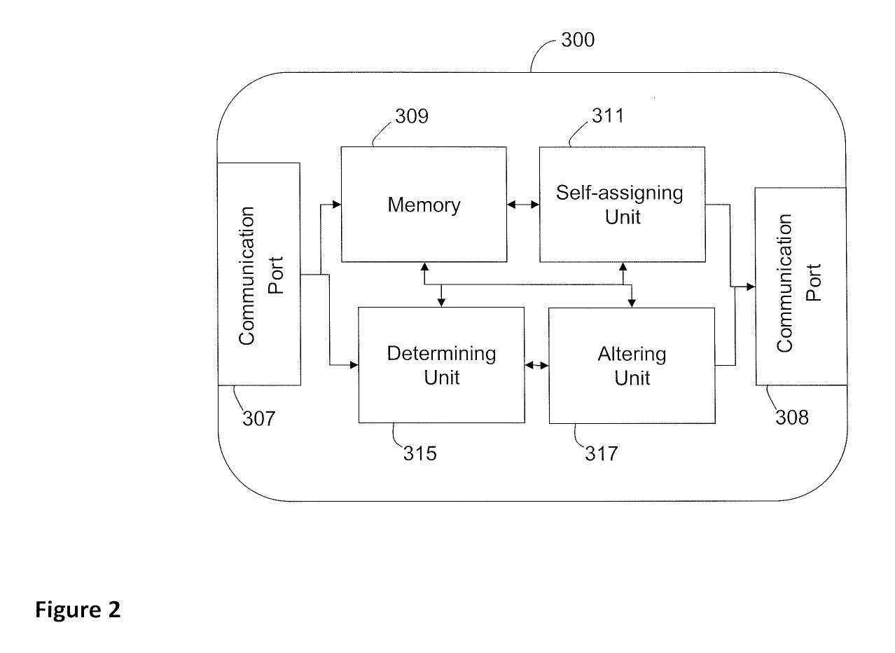

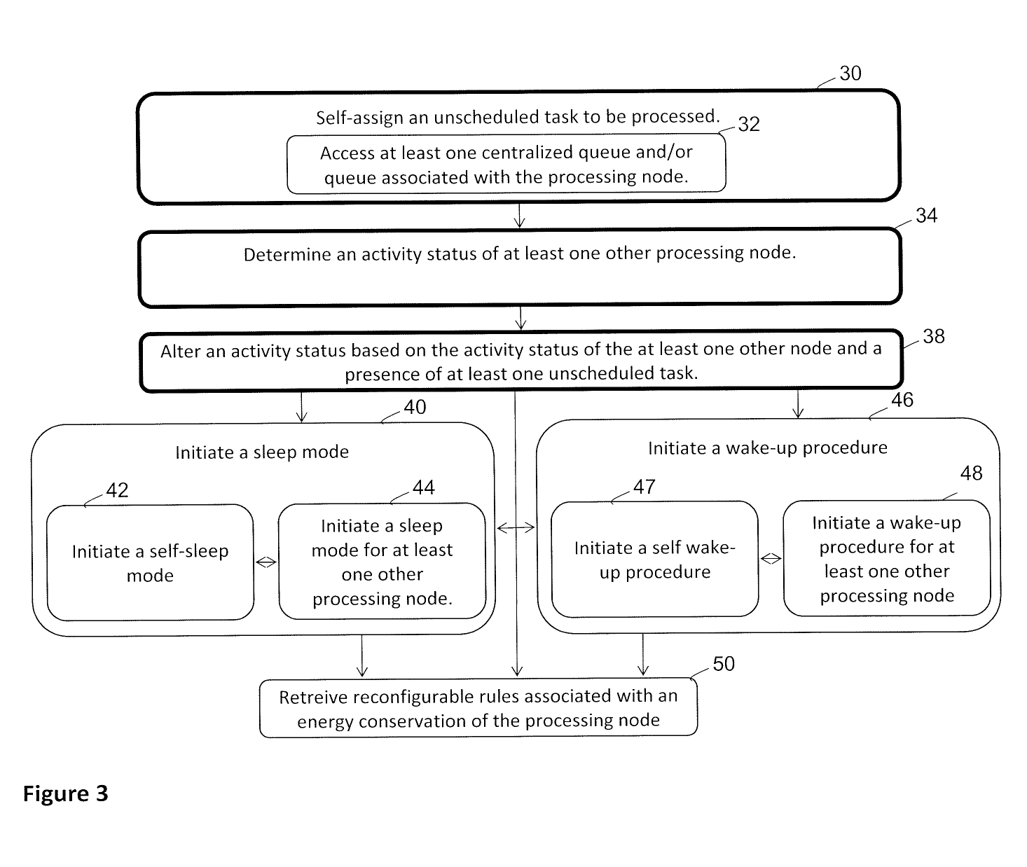

FIG. 1B illustrates a multi-core processing system, according to some of the example embodiments. In some of the example embodiments, the multi-core processing system may comprise any number of processing nodes 201A-201N. Each processing node may be any suitable type of computation unit, e.g. a microprocessor, digital signal processor (DSP), field programmable gate array (FPGA), or application specific integrated circuit (ASIC). The processing nodes 201A-201 N may comprise a processing unit 300 which may be utilized in the assignment and processing of various tasks, as well as power management. The processing unit 300 will be described in detail later on in relation to FIGS. 2 and 3.

According to some of the example embodiments, the system may comprise any number of distributed task queues 203-209. It should be appreciated that any number distributed task queues may be associated with a particular processing node. For example, processing node 201A comprises two distributed task queues 203 and 205, while processing queue 201N comprises one distributed task queue 209, and processing node 201B comprises none. It should also be appreciated that any number of distributed task queues may be shared among any number of processing nodes. For example, distributed task queue 207 is shared among processing nodes 201B and 201N.

According to some of the example embodiments, the system may also comprise any number of global task queues 211. The global task queues 211 may be accessed by the various processing nodes 201A-201N via a communication interface 213. The access may be controlled by the processing unit 300 of each processing node 201A-201N. It should be appreciated that the distributed tasks queues 203-209 and/or the global task queues 211 may be may be any suitable type of computer readable memory and may be of volatile and/or non-volatile type.

According to some of the example embodiments, the tasks may be scheduled in a non-preemptive manner, where the tasks are run to completion. Furthermore, the workload may be regulated so that the amount of active processing nodes may be fully distributed. This means that the load on each processing node is not depending on the number of processing nodes in the system. This property of the system may be valid even though the task queues are common for all processing nodes, providing a new and unique benefit of the example embodiments.

According to some of the example embodiments, processing nodes which are non-active may be put into combinations of low energy consumption modes or other low resource consumption modes. It should be appreciated that the processing nodes may also be moved into another processing node pool, for example, dedicated for less prioritized/time critical work. The use of several levels of energy saving modes may be utilized to trade response time versus energy saving. The response time normally increases together with the amount of energy saving.

FIG. 2 illustrates an example of a processing unit300 that may be comprised in the processing nodes 201A-201 N of FIG. 1B. As shown in FIG. 2, node 300 may comprise any number of communication ports 307 that may be configured to receive and transmit any form of communications or control signals within a network or multi-core processing system. It should be appreciated that the communication ports 307 may be in the form of any input/output communications port known in the art.

The processing unit 300 may further comprise at least one memory unit 309 that may be in communication with the communication ports 307. The memory unit 309 may be configured to store received or transmitted data and/or executable program instructions. The memory unit 309 may also serve as the distributed task queue described above. The memory unit 309 may be any suitable type of computer readable memory and may be of volatile and/or non-volatile type.

The processing unit 300 may further comprise a self-assigning unit 311 which may be configured to assign and/or select unscheduled tasks which are to be performed by respective processing nodes. The processing unit 300 may further comprise a determining unit 315 which may be configured to determine the presence of inactive processing nodes in the multi-core processing system. The processing unit 300 may further comprise an altering unit 317 that may be configured to alter an activity status based on the presence of at least one inactive worker. In other words, the altering unit 317 may provide power management. It should be appreciated that the functions provided by the processing unit 300 may be made in a distributed manner.

Furthermore, the self-assigning unit, determining unit, and/or the altering unit may be any suitable type of computation unit, e.g. a microprocessor, digital signal processor (DSP), field programmable gate array (FPGA), or application specific integrated circuit (ASIC). It should be appreciated that the self-assigning unit, determining unit, and/or the altering unit may be comprised as a single unit or any number of units.

FIG. 3 is a flow diagram illustrating example operations which may be taken by the processing unit 300 of FIG. 2.

### Example Operation 30:

According to some of the example embodiments, the processing unit 300 may be configured self-assign 30 an unscheduled task to be processed. The self-assignment unit is configured to perform the self-assigning 30. It should be appreciated that the term ‘self-assignment’ refers to the processing unit 300 of each individual processing node 201A-201N being configured to assign a task for its self. Thus, task assignment may be performed autonomously.

### Example Operation 32:

According to some of the example embodiments the self-assigning 30 may further comprise accessing 32 at least one centralized queue (e.g., global task queues 211) and/or at least one queue associated with the processing node (e.g., distributed task queues 203-209). The self-assignment unit may be configured to perform the accessing 32.

### Example Operation 34:

According to some of the example embodiments, the processing unit 300 may be configured to determine 34 an activity status of at least one other processing node (e.g., determining a presence of at least one inactive processing node). The determining unit is configured to perform the determining 34. Giving each processing node the knowledge of whether or not there are inactive processing nodes in the system may provide each processing node the ability to perform power management tasks autonomously.

### Example Operation 38:

According to some of the example embodiments, the processing unit 300 may be configured to alter 38 an activity status based on a presence of at least one unscheduled task and the activity status of the at least one other processing node, where the self-assigning 30 and the altering 38 are performed in a fully distributed manner. The altering unit 317 is configured to perform the altering 38.

The activity status may provide information as to whether a node is active (i.e., powered on) or inactive (i.e., in a sleep mode or powered off). It should be appreciated that the altering 38 of the activity status may be provided as a means of power management. Thus, instead of having all processing nodes fully operational at all times, processing nodes which are busy may wake-up one or more inactive processing node to ensure there is always a node available for further processing. Similarly, a processing node may also put itself or one or more other nodes to sleep. Such alteration will be explained in greater detail in the example operations and provided example flow charts below.

### Example Operation 40:

According to some of the example embodiments, the altering 38 may further comprise initiating 40 a sleep mode if a number of unscheduled tasks to be performed is below a task threshold. The altering unit may be configured to perform the initiating 40. Thus, according to some of the example embodiments, processing nodes may have the ability to put themselves or other nodes in a sleep mode as will be explained in greater detail below. It should be appreciated that the task threshold may be any number which may be pre-decided or dynamically reconfigurable depending on a current application or process.

### Example Operation 42

According to some of the example embodiments, the initiating 40 may further comprise initiating 42 a self-sleep mode. The altering unit may be configured to perform the initiating 42. Therefore, if the altering unit determines that there are not many unscheduled tasks to be performed, and depending on the activity status of at least one other processing node, the altering unit may initiate a sleep mode for the processing node the altering unit is associated with.

As an example, suppose the altering unit determines that there are no processing nodes which are inactive and there are zero unscheduled tasks to be performed (where the threshold may be two unscheduled tasks). The processing node may thereafter initiate a self-sleep state since the number of unscheduled tasks is below the task threshold and there are no inactive processing nodes. In the provided example there are enough processing nodes which are currently active and the current processing node may therefore inactivate itself to preserve system resources. It should be appreciated that the task threshold may be any number which may be pre-decided or dynamically reconfigurable depending on a current application or process.

### Example Operation 44:

According to some of the example embodiments, the initiating 40 may also comprise initiating 44 a sleep mode for at least one other processing node of the plurality of processing nodes (or the nodes comprised in the multi-core system). The altering unit may be configured to perform the initiating 44.

Therefore, similar to example operation 42, where a processing node put itself to sleep, in example operation 44 a processing node may put another processing node to sleep. The decision to put another processing node to sleep may be based on both the activity status of at least one other processing node and/or the number of unscheduled tasks. It should be appreciated that all processing nodes may be given equal opportunity to put any other processing nodes to sleep, thereby creating a fully distributed system.

It should be appreciated that the sleep modes of examples operations 40, 42, and/or 44 may be one of a plurality of different sleep modes. The use of different sleep modes may be used in order to be able to trade response time versus energy saving. Increased energy savings normally leads to a corresponding increase of response time. It should be appreciated that example operations 42 and 44 may be used as alternatives to one another or in combination. It should further be appreciated that, according to some of the example embodiments, the at least one other processing node may be, e.g., for a specific purpose of resource consumption control, an associated processing node. The associated processing node may be a neighboring processing node that is in close proximity (e.g., physically or logically) to the processing node in question. Examples of such associations may be an ordered list or a binary tree.

### Example Operation 46:

According to some of the example embodiments, the altering 38 may comprise initiating 46 a wake-up procedure. The altering unit may be configured to perform the initiating 46. Thus, a processing node may be configured to perform a self-wake-up procedure or a wake up procedure on any other processing node, as explained further below.

### Example Operation 47:

According to some of the example embodiments, the initiating 46 may further comprise initiating 47 a self-wake-up procedure after a predetermined period of time has lapsed. The altering unit may be configured to perform the initiating 46.

Thus, after a processing node has been put to sleep (i.e., put in an inactive mode), the node may be made active after a certain period of time has passed. It should be appreciated that according to some of the example embodiments, the predetermined time may be user programmable or reconfigurable depending on a current application or process.

### Example Operation 48:

According to some of the example embodiments, the initiating 46 may further comprise initiating 48 a wake-up procedure for at least one other processing node of the plurality of processing nodes (or the nodes comprised in the multi-core system) if a number of unscheduled tasks to be performed is above a task threshold. The altering unit may be configured to perform the initiating 48.

Therefore, an inactive processing node may also become active based on the operations of another processing node. It should be appreciated that example operations 47 and 48 may be used as alternatives to one another or in combination. Furthermore, it should be appreciated that according to some of the example embodiments, each processing node, or processing unit within the node, may be given equal opportunity to initiate a sleep or wake-up procedure for any other node. Thus, according to some of the example embodiments, a master-slave relationship may not exist among the processing nodes thereby making the system fully distributed.

It should further be appreciated that, according to some of the example embodiments, the at least one other processing node may be an associated processing node. The associated processing node may be a neighboring processing node that is in close proximity (e.g., physically or logically) to the processing node in question.

### Example Operation 50:

According to some of the example embodiments, the altering 38 may further comprise retrieving 50 reconfigurable rules associated with the power management of the processing node(s). The altering unit may be configured to perform the retrieving 50. Thus, all of the example operations described above (e.g., operations 34-48) may be based on reconfigurable power management rules which may be implemented within each processing unit 300.

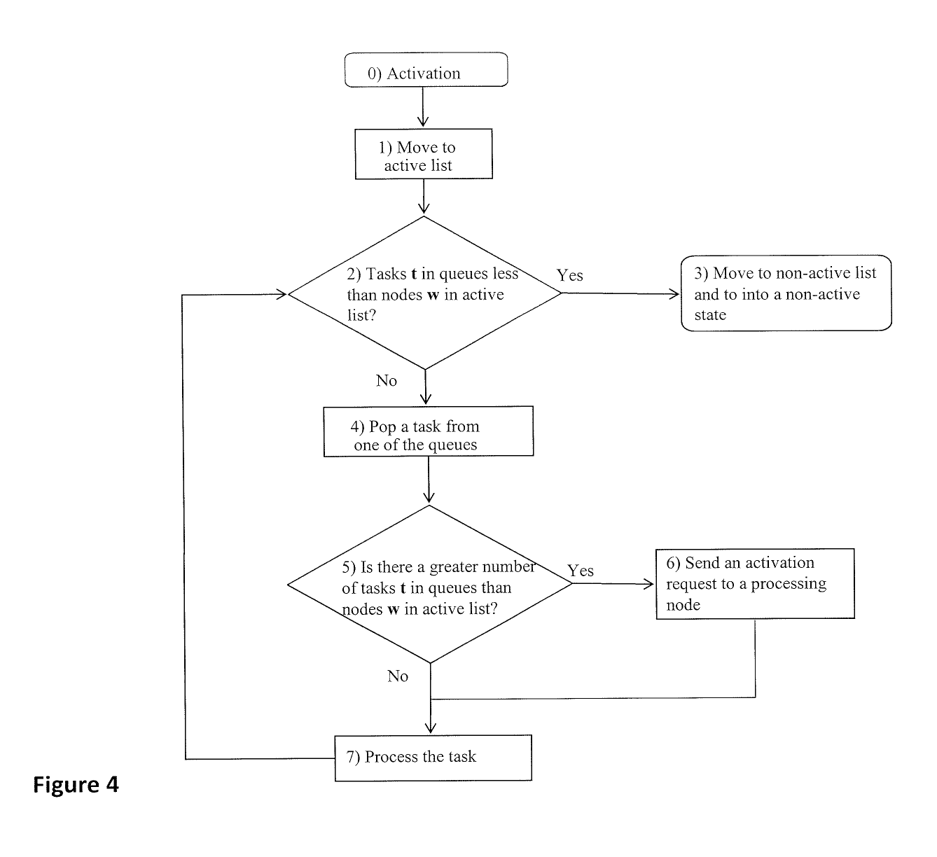

FIGS. 4-7 provide specific non-limiting examples of distributing and power management operations which may be taken by the processing node described in relation to FIGS. 2 and 3. FIG. 4 is an illustrative example of node operations which prioritize the use of low power consumption over a fast response to task processing. First, a processing node may be brought to activation or may undergo a wake-up procedure as described in example operations 46-48 (box 0). Thereafter, the processing node may be moved to an active list (box 1). The active list may comprise a list of all processing nodes in the multi-core system which are in an active state (e.g., powered on).

After being placed on the active list, a determination may be made as to whether or not there are less tasks t in global task queues 211 or distributed task queues 203-209, than processing nodes w on the active list, as described in example operation 34 and 38 (box 2). If the value of t is less than the value of w, than the processing node may be moved to a non-active list, or may initiate a sleep mode as described in example operations 40 and 42 (box 3). However, if the value of t is greater than the value of w, the processing node may retrieve a task from an available task queue (box 4).

Thereafter an evaluation may be made as to whether there are more tasks t in task queues than processing nodes w on the active list, as described in example operation 34 and 38 (box 5). If the value of t is greater than the value of w, the processing node in question may send an activation request to another processing node in the multi-core system, as described in relation to example operations 46 and 48. Thereafter, the current processing node may process retrieved task, as described in example operation 30.

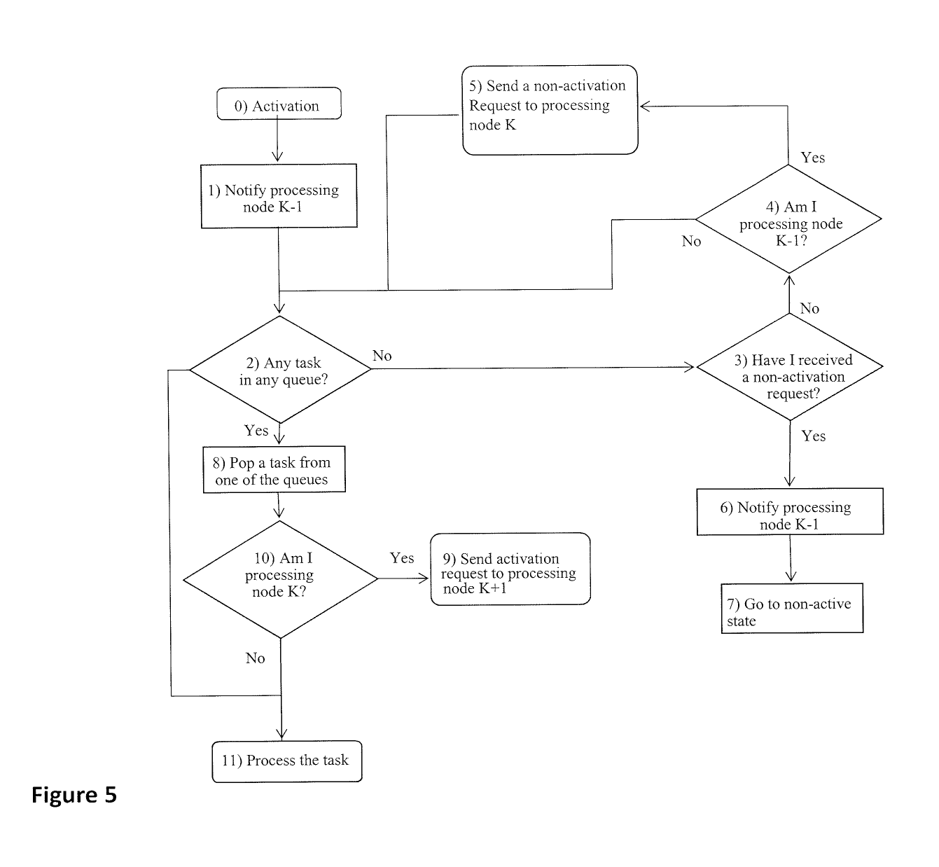

FIG. 5 is an illustrative example of node operations which prioritize a fast task processing response. In the example provided by FIG. 5, all of the processing nodes may initially be placed in an active state or mode, where after some time the processing nodes may be placed in an inactive state as described in example operations 40-44. All processing nodes which are active may be placed in a numbered active list. The active list may be numbered 1 to K, where K represents the highest numbered processing node which has been active for the shortest period of time.

First, a current node may undergo an activation process, as described in example operations 46-48 (box 0). Thereafter, the current node may notify the processing node which is the node that has been active for the second shortest-period of time (node K−1) that the current node has been activated and added to the activation list (box 1).

Thereafter, an evaluation may be made as to whether there are any tasks in any queue (or if there are any tasks below a task threshold number) (box 2). If it is determined that there are no tasks (or the available tasks to be processed are below a threshold number), another evaluation may be made. An evaluation may be made to determine if the current node has received a non-activation request or a request to enter a sleep mode, as described in example operations 40-44 (box 3).

If the current node has not received any non-activation of sleep requests, the current node may thereafter make another evaluation as to whether or not the current node has become the K−1 node in the activation list (box 4). If the current node is the K−1 numbered processing node in the activation list, the current node may initiate a sleep procedure to the K^{th} numbered processing node, as described in example operations 40 and 44 (box 5). If the current node has received a non-activation or sleep request (box 3), the current node may notify the K−1 processing node (box 6) and thereafter enter a sleep or inactive mode as described in example operations 40-44 (box 7).

If the current node determines that there are tasks in the task queue (or if the number of tasks in the queue are above a task threshold) (box 2), the current node may retrieve a task from the queue (box 8). Thereafter, the current node may make an evaluation as to whether the current node has become the K^{th} numbered processing node (box 10). If the current processing node is now the K^{th} node (i.e., the highest numbered node which is in an active state), the current node may send an activation or wake-up request, as described in example operations 46-48, to the K+1 processing node (which is currently inactive) (box 9).

If it is determined that the current processing node is the K^{th} node (box 10), then the current node may thereafter process the task (box 11). Upon processing the task, the processing node may continue to look for further tasks to be processed (box 2).

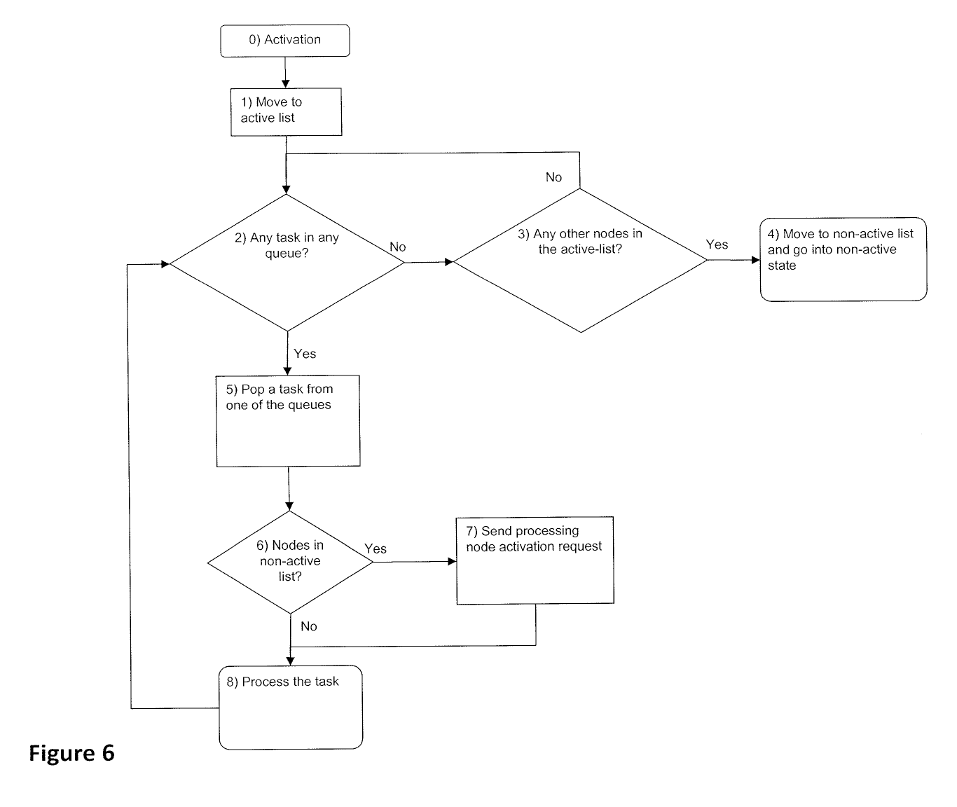

FIG. 6 is an illustrative example of node operations which prioritize a fast task processing time with an exponential ramping up of available processing nodes. First, a current node may undergo an activation process, as described in example operations 46-48 (box 0). Thereafter, the current node may move itself to the active list (box 1). Upon being placed on the active list, an evaluation may be made as to whether there are any tasks in any queues (or the number of tasks in queues may be compared with a task threshold) (box 2). If there are no tasks, an evaluation may be made to determine if there are any other processing nodes in the active list (box 3). If there are other processing nodes in the active list, the current node may place itself in a non-active list and state, as 35 described in example operations 40-44 (box 4). If it is determined that there are no other processing nodes in the active list (box 3), then the current node may stay in an active mode and continue to search for tasks to be processed (box 2).

If it is determined that there are tasks in the queues to be processed (box 2), the current node may retrieve a task and self-assign the task for processing, as explained in example operation 30 (box 5). Thereafter, another evaluation may be made as to whether there are processing nodes in the non-active list (box 6). If there are processing nodes in the non-active list, the current node may send an activation request or wake-up procedure to another processing node, as described in example operations 46 and 48 (box 7). Thereafter, and if there are no processing nodes in the non-active list, the current node may process the self-assigned task (box 8) and continue searching for unprocessed tasks in the queues (box 2).

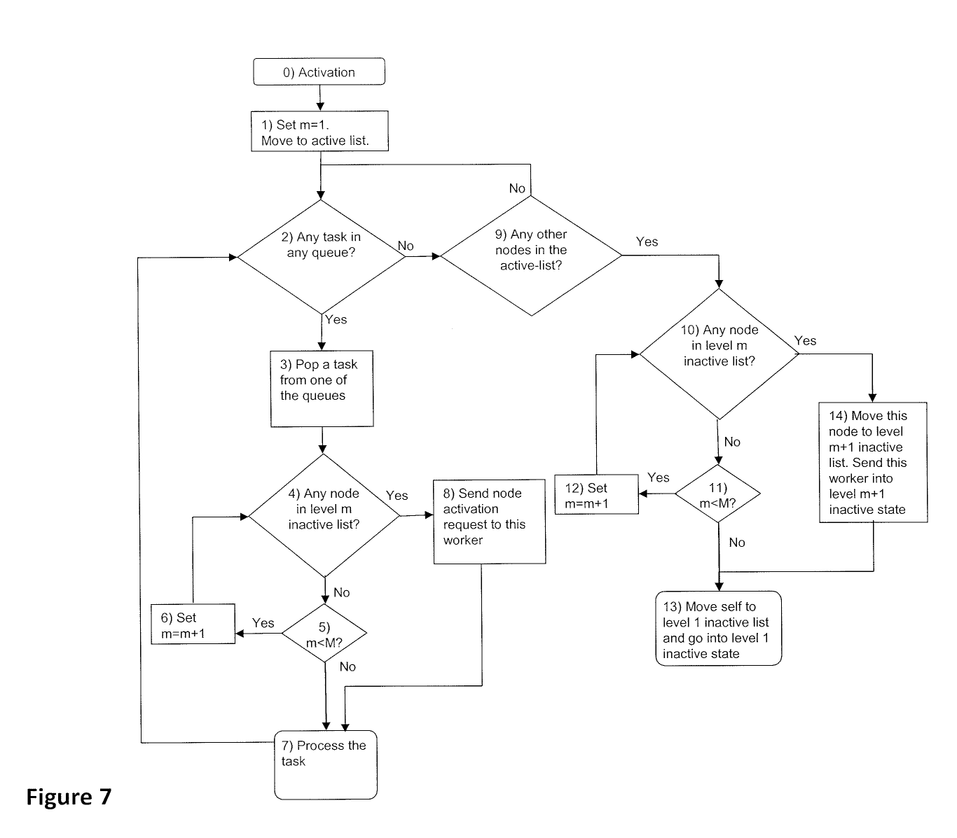

FIG. 7 is an illustrative example of example operations which prioritize a fast task processing time with an exponential ramping up of available processing nodes and the use of multiple sleep levels. In the example provided by FIG. 7, M denotes the highest sleep level (comprising of nodes which have been in a sleep state for the longest period of time) and m denotes an index of the current processing node. First, a current node may undergo an activation process, as described in example operations 46-48 (box 0). Thereafter, the index of the current node may be set to 1 (box 1). Upon setting the index of the current processing node, an evaluation may be made as to whether there are any tasks in any queues (box 2). If there are tasks to be processed, the processing node may self-assign a task as described in example operation 30 (box 3).

Upon self-assignment, an evaluation may be made as to whether there are processing nodes that are located in the m sleep level (box 4). If there are no processing nodes located in the m sleep level, another evaluation is made as to whether the current index m is smaller than the maximum sleep level M (box 5). If the current index m is smaller than the maximum sleep level M, the current index is incremented by 1 (box 6). If the current index m is not smaller than the maximum sleep level M (box 6), the task is processed (box 7). If there are processing nodes in sleep level m (box 4), then at least one processing node in sleep level m may be sent a wake-up procedure request as explained in example operations 46 and 48 (box 8).

If it is determined that there are no tasks in the queues to be processed (or the number of tasks is below a task threshold) (box 2), another evaluation may be made as to whether there are any processing nodes in the active list (box 9). If there are no processing nodes in the active list, the current processing node may stay active and continue to look for tasks which need to be processed (box 2). If there are other nodes in the active list, an evaluation may be made which is similar to that described in boxes 4-6 (boxes 10-12). However, in this evaluation, if the value of the current index m is smaller than the maximum sleep level M (box 11), the current node may initiate a level 1 self-sleep mode as explained in example operations 40 and 42 (box 13). If it is determined that there is a processing node in the current index level m sleep mode (box 10), the current node may place the processing node in the m sleep level to an m+1 sleep level (box 14).

The foregoing description of the example embodiments have been presented for purposes of illustration and description. The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Some example embodiments may comprise a portable or non-portable telephone, media player, Personal Communications System (PCS) terminal, Personal Data Assistant (PDA), laptop computer, palmtop receiver, camera, television, and/or any appliance that comprises a transducer designed to transmit and/or receive radio, television, microwave, telephone and/or radar signals. The various example embodiments described herein are described in the general context of method steps or processes, which may be implemented in one aspect by a computer program product, embodied in a computer-readable medium, including computer-executable instructions, such as program code, and executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method, in a processing node, said processing node being one of a plurality of processing nodes configured to perform parallel processing, the method comprising:
self-assigning at least one unscheduled task to be processed;
determining an activity status of at least one other processing node; and
altering an activity status based on the activity status of the at least one other processing node and a presence of at least one unscheduled task, wherein the self-assigning and altering are performed in a fully distributed manner.

2. The method of claim 1, wherein the self-assigning further comprises accessing at least one centralized queue and/or at least one queue associated with the processing node.

3. The method of claim 1, wherein the altering further comprises initiating a sleep mode if a number of unscheduled tasks to be performed is below a task threshold.

4. The method of claim 3, wherein the initiating further comprises initiating a self-sleep mode.

5. The method of claim 3, wherein the initiating further comprises initiating a sleep mode for at least one other processing node of the plurality of processing nodes.

6. The method of claim 3, wherein the initiating further comprises initiating one of a plurality of different sleep-modes.

7. The method of claim 1, wherein the altering further comprises initiating a wake-up procedure.

8. The method of claim 7, wherein the initiating further comprises initiating a self-wake-up procedure after a predetermined period of time has lapsed.

9. The method of claim 7, wherein the initiating further comprises initiating a wake-up procedure for at least one other processing node if a number of unscheduled tasks to be performed is above a task threshold.

10. The method of claim 5, wherein the at least one other processing node is an associated node.

11. The method of claim 1, wherein the altering further comprises retrieving reconfigurable rules associated with power management of the processing node.

12. A processing node, said processing node being one of a plurality of processing nodes configured to perform parallel processing, the processing node comprising:
a self-assigning unit configured to self-assign at least one unscheduled task to be processed;
a determining unit configured to determine an activity status of at least one other processing node; and
an altering unit configured to alter an activity status based on the activity status of the at least one other processing node and a presence of at least one unscheduled task, wherein the self-assigning and altering are performed in a fully distributed manner.

13. The processing node of claim 12, wherein the self-assigning unit and the determining unit are further configured to access at least one centralized queue and/or at least one queue associated with the processing node.

14. The processing node of claim 12, wherein the altering unit is further configured to initiate a sleep mode if a number of unscheduled tasks to be performed is below a task threshold.

15. The processing node of claim 14, wherein the altering unit is further configured to initiate a self-sleep mode.

16. The processing node of claim 14, wherein the altering unit is further configured it initiate a sleep mode for at least one other processing node.

17. The processing node of claim 14, wherein the altering unit is further configured to initiate one of a plurality of different sleep-modes.

18. The processing node of claim 12, wherein the altering unit is further configured to initiate a wake-up procedure.

19. The processing node of claim 18, wherein the altering unit is further configured to initiate a self- wake-up procedure after a predetermined period of time has lapsed.

20. The processing node of claim 18, wherein the altering unit is further configured to initiate a wake-up procedure for at least one other processing node of the plurality of processing nodes if a number of unscheduled tasks to be performed is above a task threshold.

21. The processing node of claim 16, wherein the at least one other processing node is an associated node.

22. The processing node of any of claim 12, wherein the altering unit is further configured to retrieve reconfigurable rules associated with power management of the processing node.

23. A system comprising a plurality of processing nodes according to claim 12.
